(19) United States
(12) Patent Application Publication
(10) Pub. No.: US 2011/0215209 A1
(43) Pub. Date: Sep. 8, 2011

(54) Supporting Tube With A Vibration Damper

(75) Inventors: Hendrik Marquar, Schweinfurt (DE); Manfred Schuler, Dittelbrunn (DE); Josef Renn, Dettelbach (DE); Klaus Stretz, Hassfurt (DE); Karin Sundermann, Sennfeld (DE); Michael Zutzmann, Schweinfurt (DE)

(73) Assignee: ZF Friedrichshafen AG, Friedrichshafen (DE)

(21) Appl. No.: 12/878,499

(22) Filed: Sep. 9, 2010

(30) Foreign Application Priority Data
Sep. 9, 2009 (DE) 10 2009 029 303.5

(51) Int. Cl. F16M 13/02

(52) U.S. Cl. 248/205.1

(57) ABSTRACT

A supporting tube for a vibration damper including an axial supporting surface on which rests an outer cylinder of the vibration damper. A fixing cap which holds a second axial supporting surface for securing the cylinder against loading in the opposing direction. The fixing cap is connected to the supporting tube by positive engagement, and separate locking elements for both parts are arranged between the fixing cap and the supporting tube, which locking elements position the outer cylinder relative to the supporting tube.

### BACKGROUND OF THE INVENTION

1. Field of the Invention

The invention is directed to a supporting tube for a vibration damper.

2. Description of the Related Art

A suspension strut comprising a supporting tube in which an exchangeable vibration damper is fixed axially as a cartridge is known from the DE 66 04 512 U. A first end of an outer cylinder is firmly supported against a step of the supporting tube, this step being formed by a base of the supporting tube.

A screw cap fixes the cylinder at the front in the area of a reciprocating piston rod. The screw cap makes it possible to exchange a defective vibration damper without having to dismantle the entire suspension strut from a chassis.

An inherent disadvantage of a screw cap is that corrosion can occur inside the screw connection. Further, a minimum thread length is needed for the screw connection, and thread connections are always comparatively expensive.

### SUMMARY OF THE INVENTION

It is the object of the present invention to realize a closure for an outer supporting tube of a vibration damper that overcomes the disadvantages known from the prior art.

According to one embodiment of the invention, separate locking elements for the fixing cap and the supporting tube that position the outer cylinder relative to the supporting tube are arranged between the fixing cap and the supporting tube.

The great advantage consists in that no threaded connection is required to connect the cap to the supporting tube. In this way, the locking elements position the cylinder directly or indirectly.

In one embodiment, the fixing cap has at its inner wall, and the supporting tube has at its outer wall, in the final mounted position of the fixing cap on the supporting tube at least one overlapping groove area in which the locking elements are arranged. The fixing cap contacts a step of the cylinder, e.g., by its bottom. Locking is carried out between the supporting tube and the fixing cap.

In one embodiment of the invention, the fixing cap has at least one coupling opening on the outer side by which the locking means can be fitted in the groove area. Thanks to the outer coupling opening, no special tool is needed to guide the locking elements into the groove area.

The supporting tube and the fixing cap have fully circumferentially extending grooves forming the overlapping groove area so that the fixing cap need not occupy a compulsory position in relation to the supporting tube in circumferential direction.

To facilitate the mounting movement, the coupling opening is oriented tangential to the overlapping groove area.

According to one embodiment, the locking elements are formed by a bendable rod. A greater overlapping angle and, therefore, a greater supporting contribution of the locking elements can be achieved in comparison to a rigid rod.

The locking elements can have a corrugated profile to compensate for shape tolerances and position tolerances in the overlapping groove area. A helical profile can also be provided.

In an alternative solution, the outer cylinder of the vibration damper has at least one groove area on the outer side and the supporting tube has at least one radial through-hole, and the groove area and the at least one radial through-hole overlap axially in the specified position of the vibration damper in the supporting tube. The locking elements are engaged by a radial closing movement.

In one embodiment of the invention, the closing position of the locking element is secured by the inner wall of the fixing cap. The fixing cap is not loaded by the supporting tube or vibration damper.

At least one pin element is used as a locking element.

To distribute the load at the supporting tube and at the cylinder, a plurality of pin elements are assembled to form a constructional unit, wherein the pin elements are connected to one another at least so as to be angularly movable.

A constructional unit formed of a plurality of pin elements, which is particularly easy to mount, is characterized in that it has a toothed rack profile in the relaxed state. The pin elements are connected to one another by flexible intermediate members so that a plurality of pin elements can form a circular shape.

To facilitate disassembly of the pin element, this pin element projects beyond the outer lateral surface of the supporting tube in the locking position.

In one embodiment of the invention, the fixing cap is constructed integral with a spring plate. A hanging spring plate, as it is called, results in a simple geometry of the supporting tube.

In a vehicle supporting spring, it is important for the introduction of force in some applications that the spring is mounted in an installation position which is defined in circumferential direction. To this end, a spring plate has a profile on which the spring can be supported in circumferential direction by its end winding. A device for preventing rotation is implemented between the fixing cap and the supporting tube so as to make possible the defined installation position of the spring plate, and, therefore, of the spring, without extensive adjustment work.

The device for preventing rotation is formed by a groove in which a radial projection engages. The groove is preferably constructed at the inner wall of the fixing cap because then there are no troublesome corners or edges at the supporting tube when the fixing cap is mounted.

The supporting tube can have a protective device for a subassembly of the vibration damper projecting from the supporting tube, the protective device being supported axially at the locking elements. A piston rod of the vibration damper located in the supporting tube, for example, is considered a subassembly. The protective device can be formed by bellows.

In one embodiment of the invention, two pin-shaped locking elements are assembled to form a U-shaped clip, and a connecting portion of the U-shaped clip for the protective device forms an axial stop. The bellows can contact axially so that the bellows are compressed when the piston rod moves inward. However, it is also possible for the stop to be operative only when the piston rod moves outward and for the bellows to undergo an expansion in length by means of the stop after a defined extended position of the piston rod. But the stop can also be snapped into the protective device, for example, and therefore operative for every movement of the piston rod.

A plurality of clip-like locking elements are fastened to the supporting tube at the fixing cap for simultaneous transmission of force from the protective device to the stop.

A pair of stirrup-shaped locking elements are arranged diametrically at the same height at the fixing cap. A lopsided state of the protective device cannot occur.

The clips, which are arranged in pairs, can be slid one inside the other for purposes of a long force transmission length of the pin-shaped locking elements relative to the supporting tube.

In one embodiment, the fixing cap and the supporting tube are connected to one another by a bayonet closure.

In order to achieve a simple geometry of the supporting tube, the supporting tube has a bayonet closure insert. This bayonet closure insert can be produced as a separate structural component part and connected to the supporting tube later in the production process.

Further, the bayonet closure insert can be connected to a spring plate. This step is also conducive to the use of a plain pipe as semi-finished product for producing the supporting tube.

According to one embodiment, the fixing cap surrounds the outer side of the bayonet closure. Accordingly, there is an axial overlapping between the fixing cap and the supporting tube so as to minimize the possibility of dirt entering the supporting tube.

The bayonet closure insert has a positive-engagement geometry acting at least in axial direction which engages with the supporting tube and/or with the spring plate. Along with the material-bond connection by means of the plastic used for the supporting tube and the fixing cap and spring plate, the positive-engagement geometry provides for an appreciably improved transmission of force between the integrated structural component parts.

To compensate for length tolerances between the vibration damper, supporting tube, and fixing cap, an axially acting preloading element is arranged between the vibration damper and the supporting tube.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention will be described more fully with reference to the following description of the drawings.

The drawings show:

FIG. 1 is a support tube in an installed state;

FIG. 2 is a sectional view in the area of the fixing cap;

FIG. 3 is a cross-sectional view in the area of the locking elements;

FIG. 4 is a perspective view with reference to FIG. 2;

FIG. 5 is locking element with reference to FIG. 2 as individual part;

FIG. 6 is a sectional view in the area of the pin-shaped locking element;

FIG. 7 is a cross-sectional view in the area of the lock with reference to FIG. 5;

FIG. 8 is a locking element with reference to FIG. 6 as individual part;

FIGS. 9-11 are a fixing cap with spring plate;

FIGS. 12-14 are a supporting tube with a protective device;

FIGS. 15-17 are an assembly of a locking element according to FIG. 13;

FIG. 18 is an overall view of a supporting tube as suspension strut;

FIG. 19 is a partial section from FIG. 18;

FIGS. 20-22 area a fixing cap as individual part; and

FIGS. 23-25 are a bayonet closure insert as individual part.

### DETAILED DESCRIPTION OF THE PRESENTLY PREFERRED EMBODIMENTS

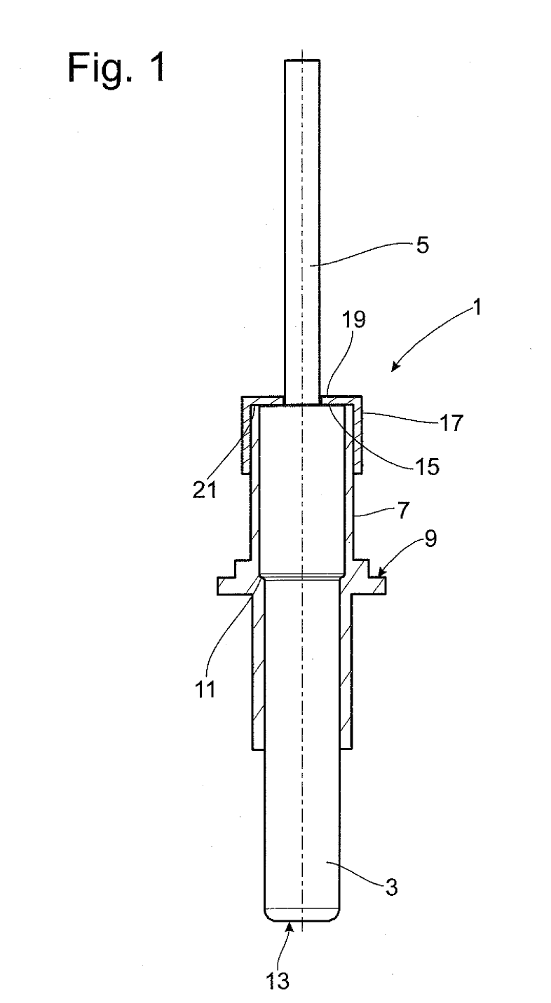

FIG. 1 is a vibration damper 1 with an outer cylinder 3 and a piston rod 5 that is axially movable in the cylinder. The exact construction of the vibration damper 1 is not relevant to the invention. At least one portion of the cylinder is enclosed by a supporting tube 7. Different mounting components can be fastened to the supporting tube 7. A spring plate 9 for a supporting spring, not shown, is illustrated by way of example, representing a vibration damper in the constructional form of a suspension strut. The supporting tube 7 is preferably made of plastic and has a long-fibered reinforcement.

The supporting tube 7 is supported axially on one side at a step 11 of the outer cylinder 3. This step 11 can be formed by a reduced diameter. However, a base 13 of the cylinder 3 can also be used as the step 11. An end face 15 of the cylinder 3 serves as a second axial supporting surface. A bottom 19 of a fixing cap 17 of the supporting tube 7 rests against this end face 15. The bottom 19 of the fixing cap 17 has a through-hole for the piston rod 5. Depending on the position of an end surface 21 of the supporting tube 7 in relation to the end face of the outer cylinder 3 of the vibration damper 1, the supporting tube 7 is arranged at the vibration damper 1 to be substantially free from play axially or so as to have freedom of movement axially.

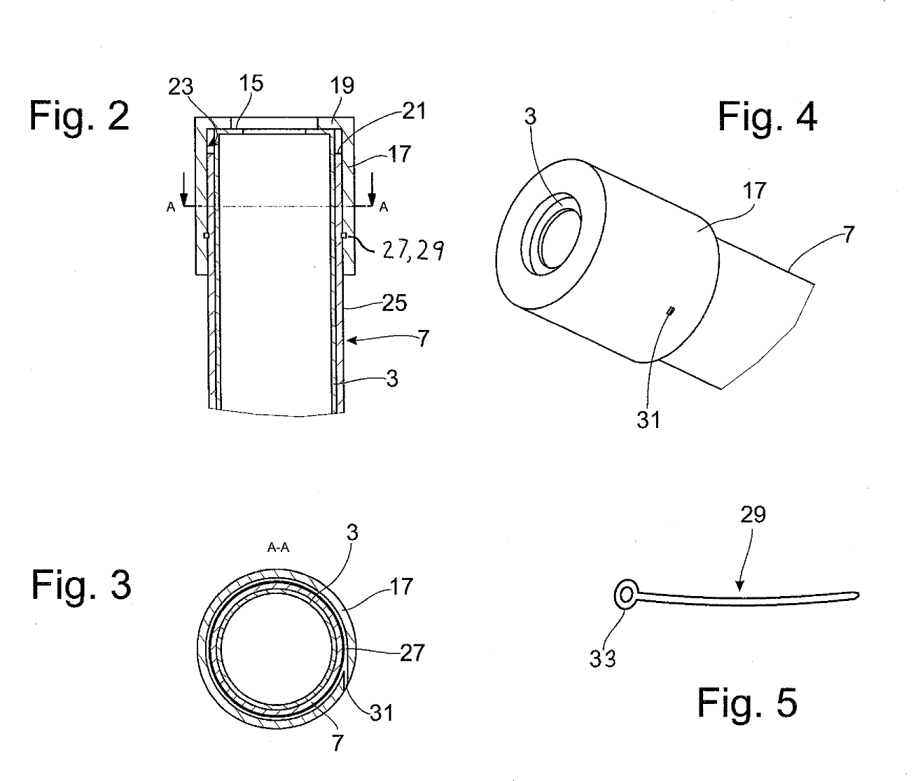

FIG. 2 is limited to showing the outer cylinder 3, the supporting tube 7 and the fixing cap 17. In this depiction, it can be seen that the supporting tube 7 is fastened to the cylinder 3 to be substantially free from play. The fixing cap 17 has, at its inner surface 23, and the supporting tube 7 has, at its outer surface 25, in the final mounted position of the fixing cap 17 on the supporting tube 7 at least one overlapping groove area 27 in which locking element 29 is arranged. Viewed in conjunction with FIG. 3, FIG. 2 illustrates the principle of construction. Accordingly, locking element 29 is arranged for the fixing cap 17 and the supporting tube 7, separately for both parts 17; 7, and these locking elements 29 position the outer cylinder 3 relative to the supporting tube 7 along the bottom 19.

As can be seen from FIGS. 3 and 4, the fixing cap 17 has at least one outer coupling opening through which the locking element 29 can be mounted in the groove area 27.

Both the supporting tube 7 and the fixing cap 17 have grooves that extend completely around their respective circumferences mating that form the overlapping groove area. Consequently, the fixing cap 17 can be mounted on the supporting tube 7 in any position in circumferential direction.

To facilitate assembly of the locking element 29, the coupling opening 31 is oriented tangential to the overlapping groove area. As is shown in FIG. 5, the locking elements 29 are formed by a bendable rod. The locking element 29 itself can have a corrugated profile or a helical profile. A handling portion 33 at its end facilitates disassembly of the locking elements 29, e.g., when the vibration damper 1 is to be removed from the supporting tube. As is shown in FIG. 3, the locking elements can under no circumstances exit the groove area axially because it is completely enclosed within the groove area 27. When the fixing cap 17 does not occupy its prescribed mounting position, the locking elements 29 can then also not be inserted, so an error in the mounting process is easily detectable.

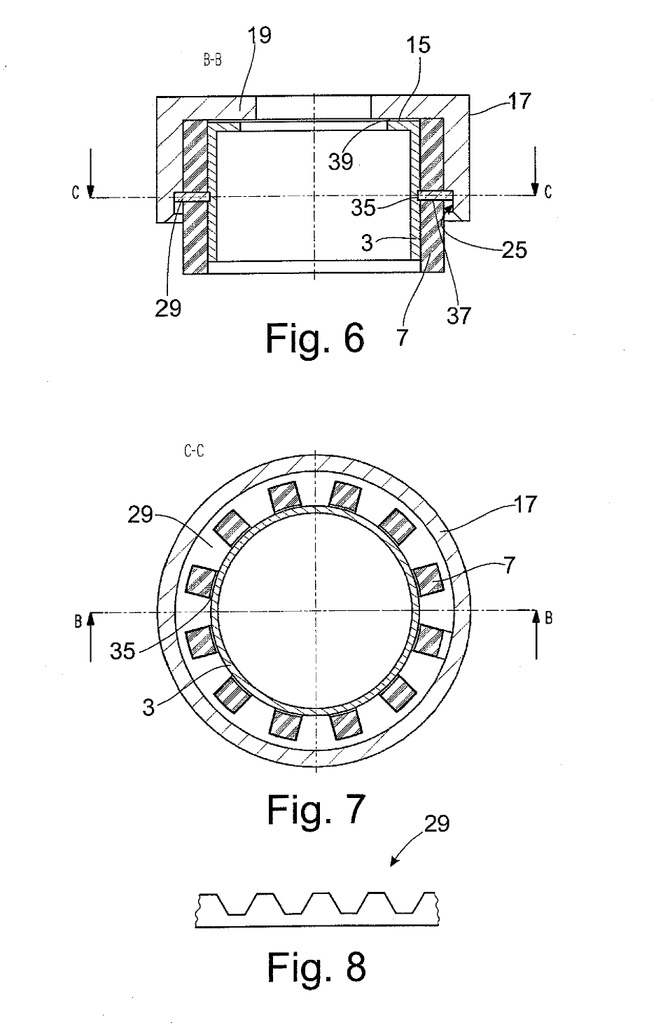

FIGS. 6 to 8 describe a variant in which the outer cylinder 3 of the vibration damper 1 has at least one groove area 35 on the outer side and the supporting tube 7 has at least one radial through-hole 37, wherein the groove area 35 and the at least one radial through-hole 37 overlap axially in the specified position of the vibration damper 1 in the supporting tube 7, and the locking element 29 is made to engage in the groove area 35 by a radial closing movement.

To ensure the closing position of the locking elements 29, the locking element 29 is secured by the inner surface wall 25 of the fixing cap 17. The locking elements 29 are prevented from sliding out of the through-hole 37 radially.

At least one pin element is used as locking element. FIGS. 7 and 8 show that a plurality of pin elements are assembled to form a constructional unit, the pin elements being connected to one another at least so as to be angularly movable. The constructional unit has a toothed rack profile in the relaxed state, and can be put into a circular arc shape so that all of the pin elements are engaged. This construction has the additional advantage that the pin elements are prevented from sliding out because of their angular position (see FIG. 7). The individual pin elements can be oriented so as to be slightly interlocking and accordingly form a corrugated profile.

To facilitate disassembly of the pin elements, these pin elements project beyond the outer lateral surface of the supporting tube in the locking position. The protruding ends are covered by a cap so that no injuries can result from handling the constructional unit comprising the vibration damper and supporting tube.

As can be seen in FIG. 6, there is an axial gap 39 between the end face 15 of the cylinder 3 and the bottom 19 of the fixing cap 17. This gap ensures that the fixing cap 17 is not exposed to axial loading when the supporting tube 7 or cylinder 3 is loaded.

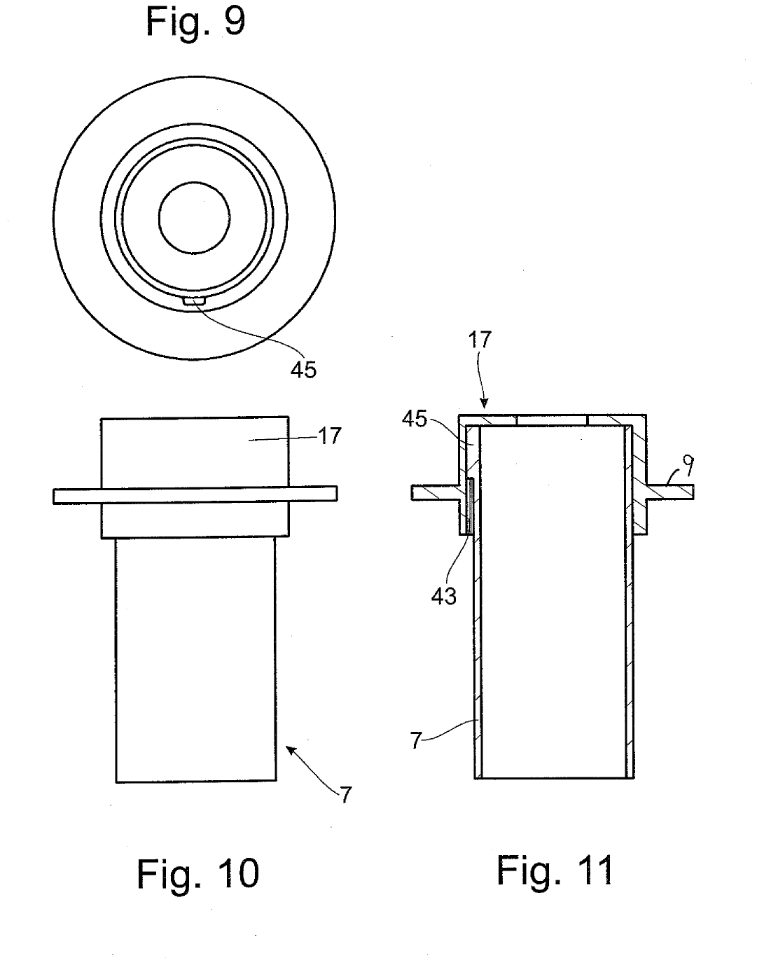

FIGS. 9-11 show a fixing cap 17 which is constructed integral with a spring plate 9. Means for preventing rotation are implemented between the fixing cap 17 and the supporting tube 7 and are formed by a groove 43 in which a radial projection 45 of the supporting tube 7 engages. The locking elements 29 according to FIG. 5 are not shown. However, this solution can also be used in principle in the variant according to FIG. 6.

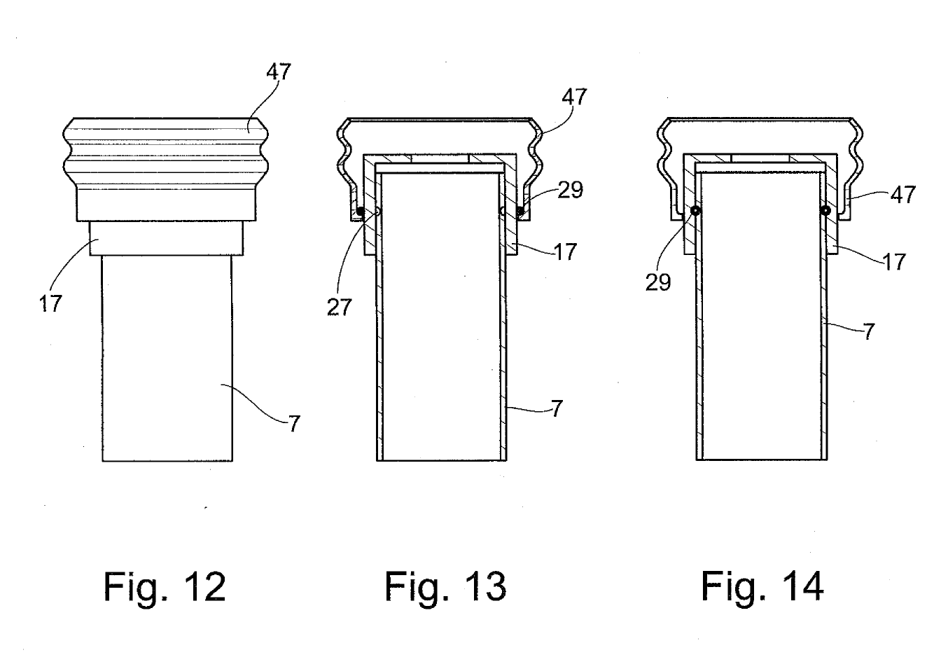

FIGS. 12 to 14 show a supporting tube 7 at which is arranged a protective device 47 designed as bellows. The protective device 47 is supported axially at the locking element 29. In this case, a receding movement of the supporting tube 7 is prevented by the protective device 47. However, it is also possible for the protective device 47 to be supported axially at the locking elements 29 during a compressing movement or for the protective device to be fitted to the locking element 29 on both sides so that both forms of movement of the protective devices are supported by the locking element 29.

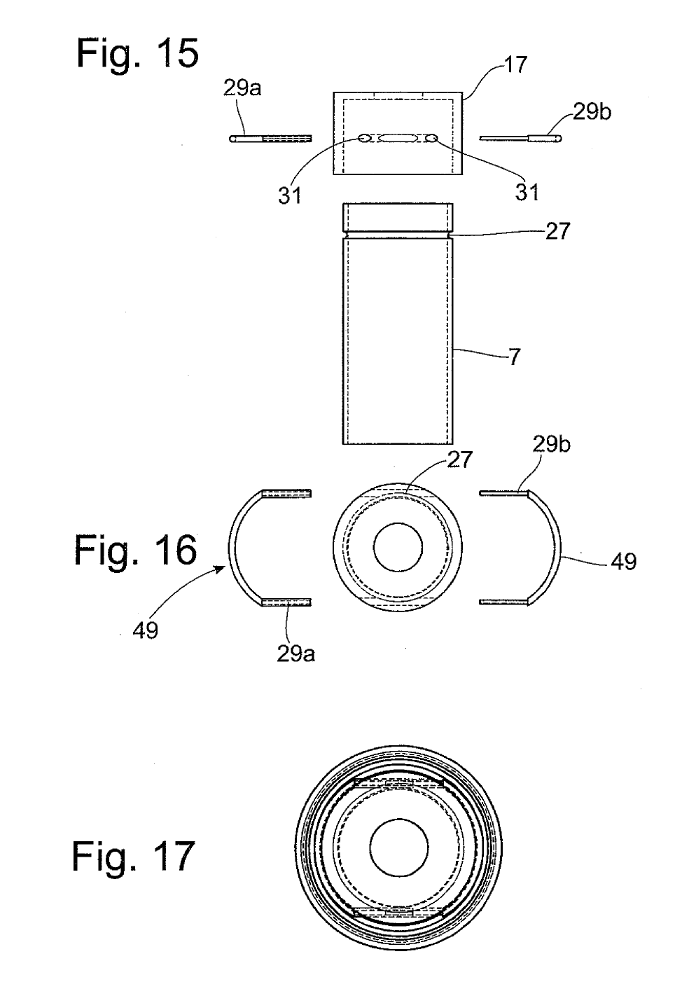

FIGS. 15 to 17 show the locking elements 29 with reference to FIGS. 12 to 14. Two parallel pin-shaped locking elements 29 are joined by a connecting portion 49 to form a U-shaped clip. The connecting portion 49 forms the axial stop of the protective device. The locking elements 29 could also simply be allowed to project out over the lateral surface of the fixing cap 17, but the stop surface would then be appreciably smaller than that produced by the curved connecting portion 49, the bend radius being adapted to the geometry of the lateral surface of the fixing cap 17.

In this embodiment example, a pair of stirrup-shaped locking elements which are arranged at the same height diametrically are used at the supporting tube 7 and fixing cap 17. The sequence of FIGS. 15 to 17 shows that locking elements 29a are constructed to be hollow and can receive a length of the opposite locking means 29b. When the vibration damper 1 is arranged in the supporting tube 7, the fixing cap 17 is pushed onto the supporting tube 7. The locking elements 29a; 29b are then slid into the groove area 27 via the coupling openings 31. In so doing, locking elements 29b engage in locking elements 29a which are partially constructed in the shape of a sleeve. Because of the axial overlap between the supporting tube 7 and the locking means 29 on one hand and the overlap between the fixing cap 17 and locking elements 29 on the other hand, the fixing cap 17 is arranged so as to be stationary with respect to the supporting tube 7. When the protective device 47 is mounted, the locking elements 29a; 29b cannot slide out of the groove area 27 because the protective device 47 radially encloses the connecting portions 49 of the locking elements 29a, 29b.

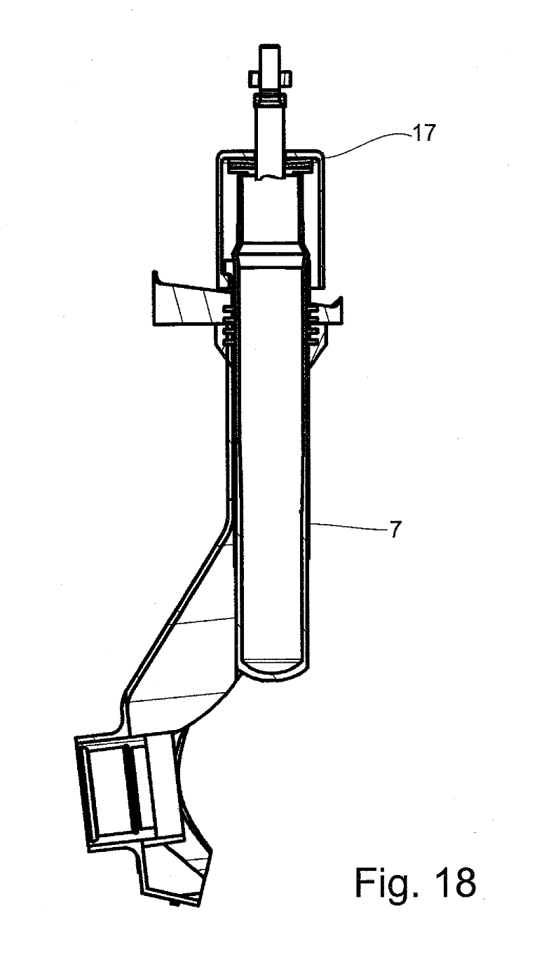

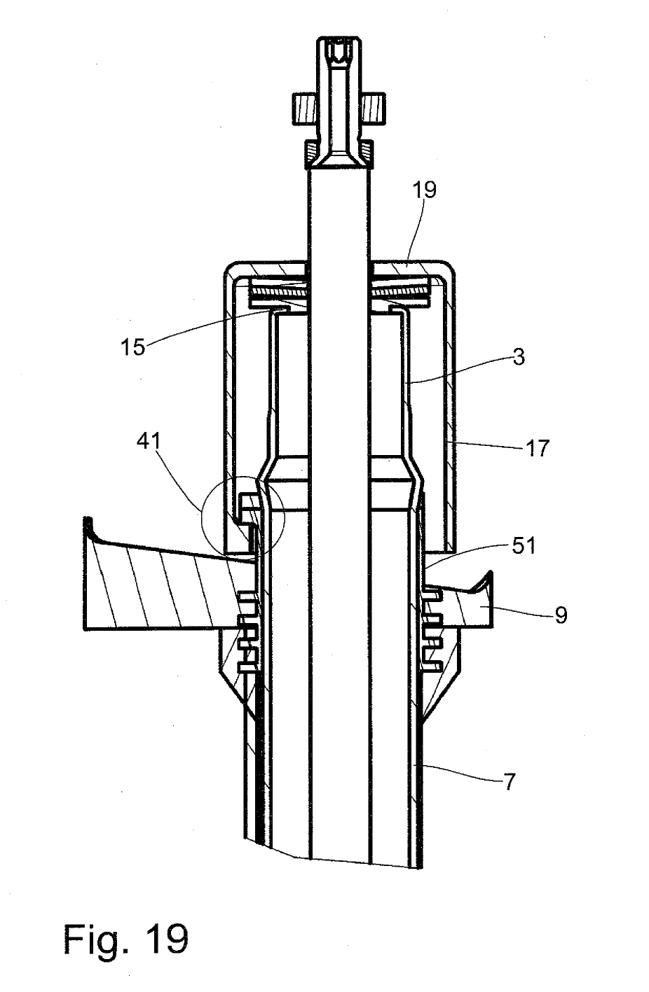

FIG. 18 shows a supporting tube 7 in more detail than in FIG. 1, its fixing cap 17 being connected to the supporting tube 7 by a bayonet closure 41 (FIG. 19). The spring plate 9 is arranged at the supporting tube 7. Further, the supporting tube 7 comprises a bayonet closure insert 51 which is likewise preferably made of a plastic of the same type as the supporting tube 7. There is a positive-engagement geometry 53 (FIG. 24) between the spring plate 9 and the bayonet closure insert 51 and relative to the supporting tube 7 for the transmission of axial forces. By way of example, annular ribs are used which are surrounded by the plastic of the spring plate 9 and/or supporting tube 7.

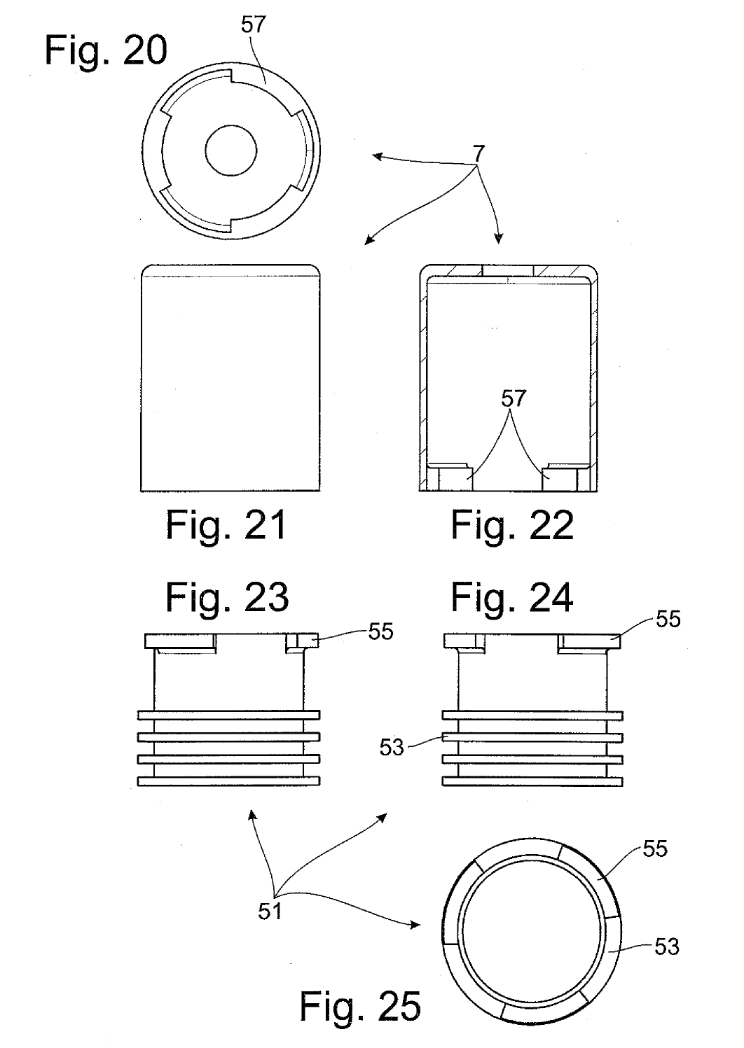

FIGS. 20 to 22 show the fixing cap 17 with reference to FIGS. 18 and 19 as an individual part. In the corresponding installation position, FIGS. 23 to 25 illustrate the design of the bayonet closure insert 51. Arc-shaped segments 55 are constructed on the outer side at the end of the bayonet closure insert 51 facing in direction of the fixing cap 17. Arc-shaped segments 57 are also formed at the fixing cap 17, wherein the voids between the segments 55, 57 are dimensioned in such a way that the fixing cap 17 can be pushed over the bayonet closure insert 51 on the outer side. Accordingly, the fixing cap can surround the bayonet closure insert 41 on the outer side. The bayonet closure 41 is engaged simply by rotating the fixing cap 17 relative to the supporting tube 7. As is shown in FIG. 19, an axially acting preloading element 57, e.g., in the form of one or more disk springs, can optionally be inserted between the end face 15 of the outer cylinder 3 and the bottom 19 of the fixing cap 17.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

We claim:

1. A supporting tube for a vibration damper comprising:
an outer cylinder of the vibration damper;
an axial supporting surface on which rests the outer cylinder;
a second axial supporting surface for securing the outer cylinder;
a fixing cap configured to hold the second axial supporting surface for securing the outer cylinder against loading in an opposing direction connected to the supporting tube by positive engagement; and
a separate locking element for the fixing cap and the supporting tube arranged between the fixing cap and the supporting tube configured to position the outer cylinder relative to the supporting tube.

2. The supporting tube according to claim 1, wherein
the fixing cap comprises at its inner wall a cap groove area, and
the supporting tube comprises at its outer wall a wall groove,
wherein, in the final mounted position of the fixing cap on the supporting tube, the respective grooves overlap and the locking element is arranged in the overlapping grooves.

3. The supporting tube according to claim 2, wherein the fixing cap comprises at least one coupling opening on an outer side by which the locking element can be fitted in the overlapping grooves.

4. The supporting tube according to claim 2, wherein the supporting tube and the fixing cap each comprise respective completely circumferentially extending grooves forming the overlapping grooves.

5. The supporting tube according to claim 3, wherein the at least one coupling opening is substantially tangential to the overlapping grooves.

6. The supporting tube according to claim 1, wherein a bendable rod forms the locking element.

7. The supporting tube according to claim 1, wherein the locking element has a corrugated profile.

8. The supporting tube according to claim 1, wherein
the outer cylinder of the vibration damper has at least one groove area on the outer side and
the supporting tube has at least one radial through-hole,
wherein the groove area and the at least one radial through-hole overlap axially in a specified position of the vibration damper in the supporting tube, the locking element configured to engage in the groove area in a radial closing movement.

9. The supporting tube according to claim 8, wherein the inner wall of the fixing cap secures a closing position of the locking element.

10. The supporting tube according to claim 8, wherein at least one pin element is used as the locking element.

11. The supporting tube according to claim 10, wherein a plurality of pin elements are connected to one another at least so as to be angularly movable and joined to form a constructional unit.

12. The supporting tube according to claim 11, wherein the constructional unit has a toothed rack profile in a relaxed state.

13. The supporting tube according to claim 8, wherein the pin element projects beyond an outer lateral surface of the supporting tube in the locking position.

14. The supporting tube according to claim 1, wherein the fixing cap is oriented circumferentially with respect to the supporting tube independent from the locking element by a rotation preventer.

15. The supporting tube according to claim 1, wherein the fixing cap is constructed integral with a spring plate.

16. The supporting tube according to claim 14, wherein the rotation preventer is formed by a groove in which a radial projection engages.

17. The supporting tube according to claim 1, wherein the supporting tube comprises a protective device for a subassembly of the vibration damper projecting from the supporting tube, wherein the protective device is supported axially at the locking element.

18. The supporting tube according to claim 17, wherein two pin-shaped locking elements are assembled to form a U-shaped clip, wherein a connecting portion of the U-shaped clip for the protective device forms an axial stop.

19. The supporting tube according to claim 18, wherein the fixing cap is fastened to the supporting tube by plurality of clip-like locking elements.

20. The supporting tube according to claim 18, further comprising a pair of stirrup-shaped locking elements arranged diametrically at a same height at the fixing cap.

21. The supporting tube according to claim 20, wherein the pin-shaped locking elements of the clips that are arranged in pairs are configured to slide one inside the other.

22. The supporting tube according to claim 1, wherein the fixing cap and the supporting tube are connected to one another by a bayonet closure.

23. The supporting tube according to claim 22, wherein the supporting tube comprises a bayonet closure insert.

24. The supporting tube according to claim 23, wherein the bayonet closure insert is connected to a spring plate.

25. The supporting tube according to claim 21, wherein the fixing cap surrounds an outer side of the bayonet closure.

26. The supporting tube according to claim 23, wherein the bayonet closure insert has a positive-engagement geometry acting at least in an axial direction that engages with at least one of the supporting tube and a spring plate.

27. The supporting tube according to one of claim 1, wherein an axially acting preloading element is arranged between the vibration damper and the supporting tube.
